(19) United States
(12) Patent Application Publication
(10) Pub. No.: US 2010/0038172 A1
(43) Pub. Date: Feb. 18, 2010

(54) FALL RESTRICTING SYSTEM

(76) Inventor: Robert Ralston, Guelph (CA)

Correspondence Address: MILLER THOMSON LLP, 100 STONE ROAD WEST, SUITE 301, GUELPH, ON, N1G-5L3, CA

(21) Appl. No.: 12/538,269

(22) Filed: Aug. 10, 2009

Related U.S. Application Data
(60) Provisional application No. 61/088,476, filed on Aug. 13, 2008.

(51) Int. Cl. E06C 7/18

(52) U.S. Cl. 182/107

(57) ABSTRACT

A fall restricting system for use by a person having a ladder, a stabilizing system adapted to engage the ladder and ground and an anchoring system adapted to engage the ladder and the person.

### FIELD OF THE INVENTION

The present invention relates to a safety system for use with ladders and more particularly a system that restricts a person's fall from a ladder.

### BACKGROUND OF THE INVENTION

The majority of accidents associated with ladders are falls that usually result in broken bones. Generally the accidents are the a result from one of the following three causes, a person over reaches and the ladder tips sideways, a person does not transfer their weight properly when moving from a roof to the ladder, therefore resulting in the ladder falling, and the base of the ladder slips outward while the person is standing on the ladder.

Typically ladder accidents occur at the work place and are a major industrial concern and these accidents cost government institutions millions of dollars in benefit claims for the injured persons. Historically the methods of trying to prevent the three most common causes of ladder accidents have not been successful. In particular, any tampering with a ladder that results in additional holes in the ladder, can result in the loss of certification by safety associations and unions, as well as the loss of the manufacture's warranty and liability.

Typically methods of securing a ladder have been simple concepts such as tying a rope around the ladder and to a static structure. Anchoring systems that secure the person to the ladder have also been typically a rope attached to the person and then to the ladder in some fashion. These methods have only superficially addressed the safety of working on a ladder and do not allow the person to safely work on the ladder in a hands-free mode.

What is needed therefore is a system that works with the existing structure of a ladder and providing an ability to restrict a person's fall to avoid injury, while overcoming the limitations and disadvantages of the prior art.

### SUMMARY OF THE INVENTION

An object of the invention is to provide an improved fall restricting system to be used with a conventional ladder

In one aspect of the present invention there is provided fall restricting system for use by a person having a ladder, a stabilizing system adapted to engage the ladder and a ground and an anchoring system adapted to engage the ladder and the person.

Preferably the stabilizing system includes at least one support arm for engaging the ladder and a least one stabilizing arm. The stabilizing arm is adapted to engage the ground and at least one adjusting means. Conveniently the stabilizing system may be engaged on one side of the ladder or on both sides of the ladder depending on positioning of the ladder relative to the object it is being leaned against.

Preferably the anchoring means includes at least one holding member adapted to engage the ladder and a detachable securing means adapted to detachably engage both the holding member and the person.

The present invention comprises the following general advantages: the fall restricting system can withstand up to 4000 pounds of weight when engaged, the fall restricting system prevents the ladder from tipping side to side, the fall restricting system prevents the base of the ladder from kicking out, the fall restricting system has a maximum fall distance for the person of nine inches when engaged, allows for hands-free work by the person while in total safety, the fall restricting system does not allow the person to lean back too far therefore allowing the ladder to move and the fall restricting system does not disrupt the integral aspects of the ladder therefore not jeopardizing certification.

### BRIEF DESCRIPTION OF THE DRAWINGS

A detailed description of the preferred embodiments is provided herein below by way of example only and with reference to the following drawings, in which:

FIG. 1 is a perspective view of the preferred embodiment of the fall restricting system.

FIG. 2 is an exploded view of the stabilizing system mounted to the ladder of the fall restricting system of FIG. 1.

FIG. 3 is a front plan view of the fall restricting system as shown in FIG. 1.

FIG. 4 is a front plan view of the adjustability of the stabilizing system of the fall restricting system of FIG. 1.

FIGS. 5a to f are partial side views showing the adaptability of the feet of the stabilizing system of the fall restricting system of FIG. 1.

FIG. 6 is an exploded front view of the anchoring system of the fall restricting system.

FIG. 7 is a front view of the anchoring system of the fall restricting system.

FIGS. 8a to c are partial views of the holding members of the anchoring system of the fall restricting system of FIG. 1.

FIG. 9a shows the insertion of the holding member into the ladder of the fall restricting system of FIG. 1.

FIG. 9b shows the first insertion of the holding member into the ladder of the fall restricting system.

FIG. 9c shows the second insertion of the holding member into the ladder of the fall restricting system.

FIG. 9d shows the securing means being positioned on the anchoring system of the fall restricting system.

FIG. 9e shows the attachment of the securing means on the anchoring system.

FIG. 10 shows the person positioned securely on the ladder using the fall restricting system.

FIGS. 11a to b show the hands-free aspect of the anchoring system and allowable movement of the person.

FIGS. 12a to e show the maximum distance the person can lean back and fall down the ladder using the fall restricting system.

FIGS. 13a to b show the person hanging on the ladder using the fall restricting system without the ladder moving.

In the drawings, one embodiment of the invention is illustrated by way of example. It is to be expressly understood that the description and drawings are only for the purpose of illustration and as an aid to understanding, and are not intended as a definition of the limits of the invention.

### DETAILED DESCRIPTION OF THE INVENTION

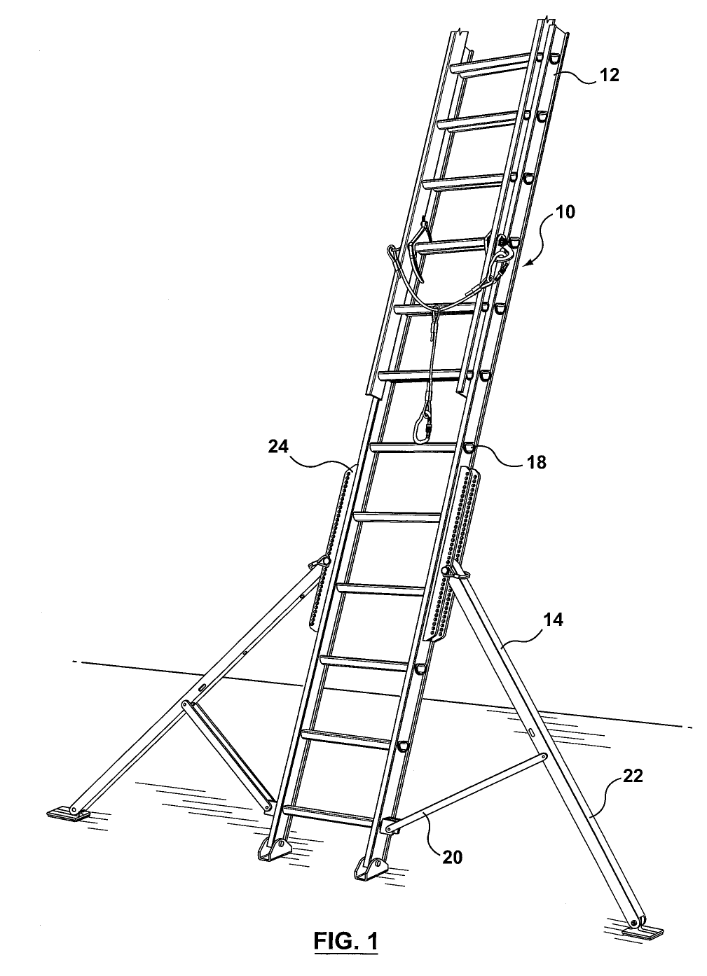

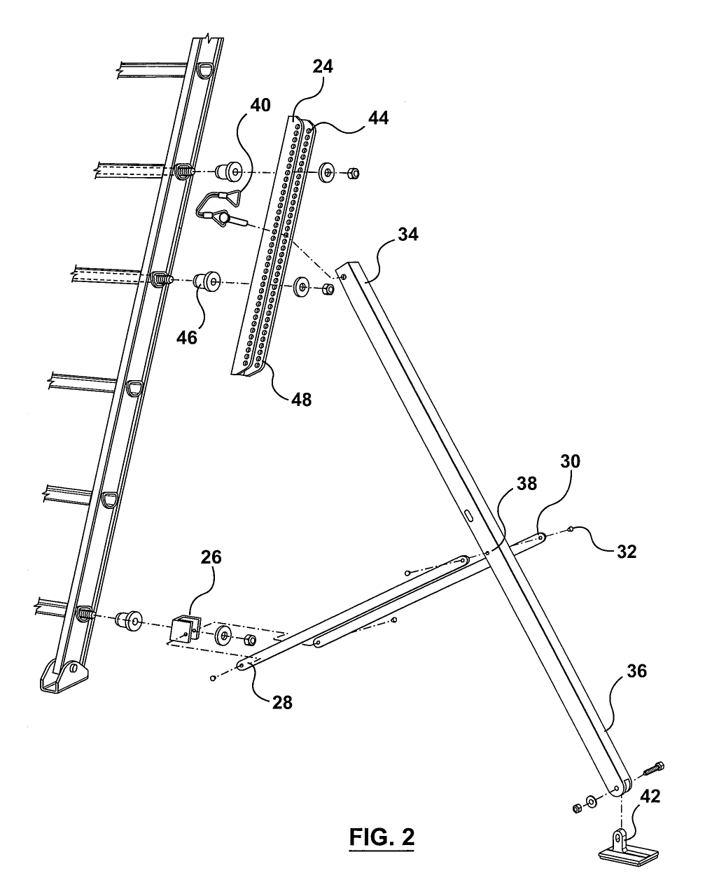

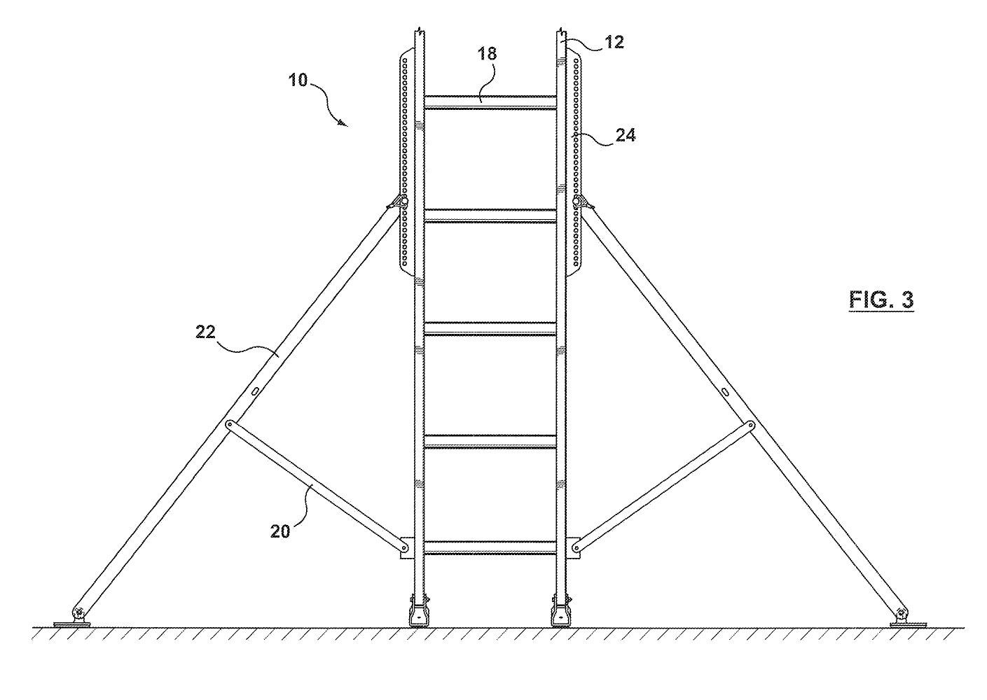

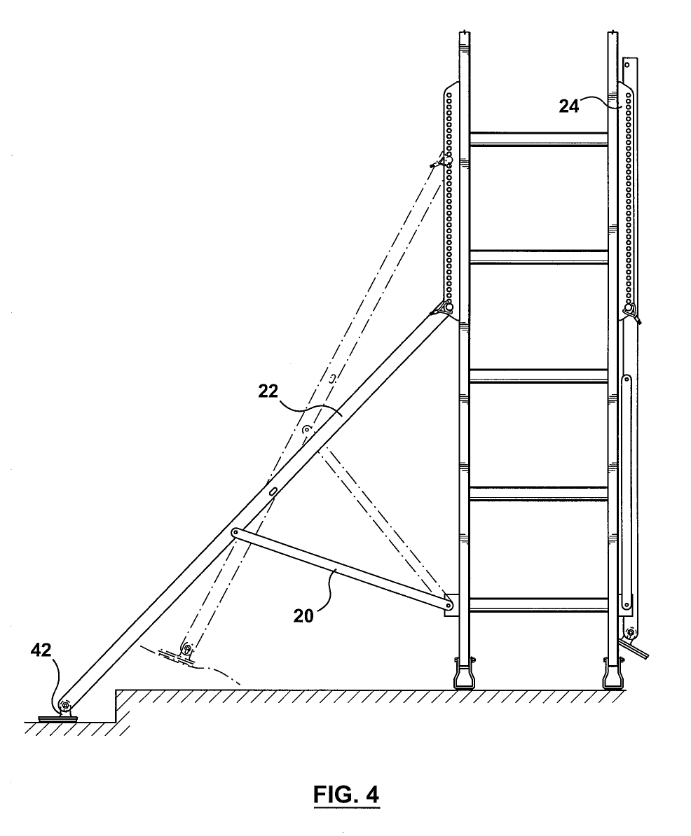

Referring to FIGS. 1 to 4 there is described a fall restricting system 10 for use by a person in accordance with the preferred embodiment of the present invention. The fall restricting system 10 includes a ladder 12, a stabilizing system 14 adapted to pivotally engage the ladder 12 and ground, and an anchoring system 16 adapted to engage the ladder 12 and the person.

The ladder 12 may be a Grade 1 ladder 12 having hollow rungs 18. The stabilizing system 14 may include at least one support arm 20 for pivotally engaging the ladder 12 and a least one stabilizing arm 22. The stabilizing arm 22 is adapted to engage the ground and at least one adjusting means 24. The support arm 20 includes a first end 28 and a second end 30 and may be removably mounted to the ladder 12 via an attachment system 26 at the first end 28. The attachment system 26 may include a threaded support that is inserted into the hollow rung 18 of the ladder 12. Secured to the threaded support is a bracket to which the first end 28 of the support arm 20 may be secured to by a nut and bolt, by way of example only. The support arm 20 is therefore allowed to pivot relative to the ladder 12. The second end 30 of the support arm 20 may be secured to the stabilizing arm 22 using a nut and bolt system 32 thereby allowing the support arm 20 to pivot relative the stabilizing arm 22. Preferably there are two support arms 20 mounted to the ladder 12 and to the stabilizing arm 22.

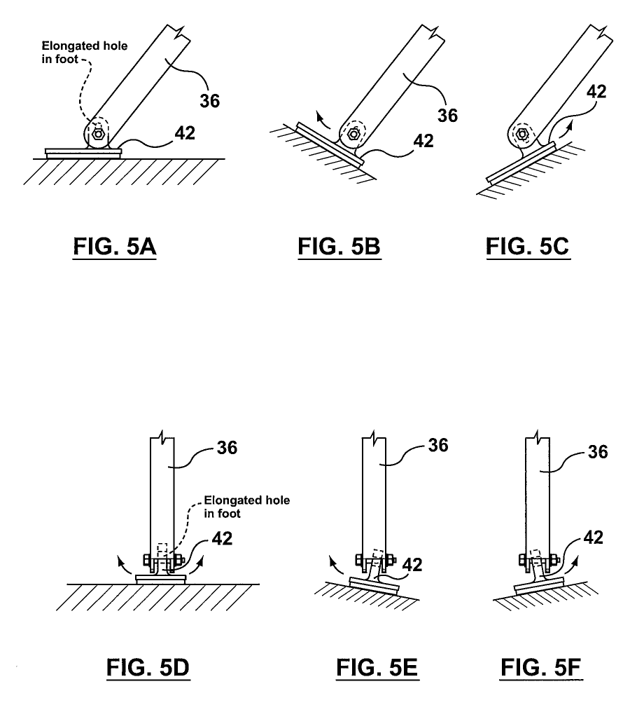

The stabilizing arm 22 may be further defined as having a first end 34 and a second end 36. The support arm 20 may engage the stabilizing arm 22 at a mid-point 38 along the stabilizing arm 22. The first end 34 of the stabilizing arm 22 is adapted to pivotally engage the adjusting means 24 using a lock and pin system 40. The second end 36 of the stabilizing arm 22 is adapted to engage a pivoting footing member 42. Referring to FIGS. 5a to f, the pivoting footing member can pivot and flex to allow for different terrain when positioning the ladder 12. The pivoting footing member 42 can pivot up and down as well as from side to side by using an elongated slot in the footing member 42.

The adjusting means 24 may be further defined as a bracket 44 to fit against the side of the ladder 12 and be secured to the ladder 12 through an attachment means 46. The bracket 44 further includes a series of apertures 48 that are adapted to engage the first end 34 of the stabilizing arm 22 and the lock and pin system 40 so as allow the stabilizing arm 22 to pivot relative the adjusting means 46.

To engage the stabilizing system 14, the stabilizing arm 22 may be pulled away from the ladder 12 by the pivoting of the first end 34 of the stabilizing arm 22 relative the adjusting means. As the stabilizing arm 22 is extended the supporting arm 20 pivots out and down relative to the ladder 12. The footing member 42 can pivot and engage the ground at any angle thereby allowing the fall restricting system to engage in any terrain. Typically each side of the ladder 12 has a stabilizing system 14 removably mounted to each side of the ladder 12. One stabilizing system 14 or on both on each side of the ladder 12 may be deployed depending on positioning of the ladder relative to the object it is being leaned against. Collapsing the stabilizing systems 14 allows for easy storage of the fall restricting system. The stabilizing systems 14 may be removed from the ladder 12 at any time while keeping with the integrity of the ladder 12.

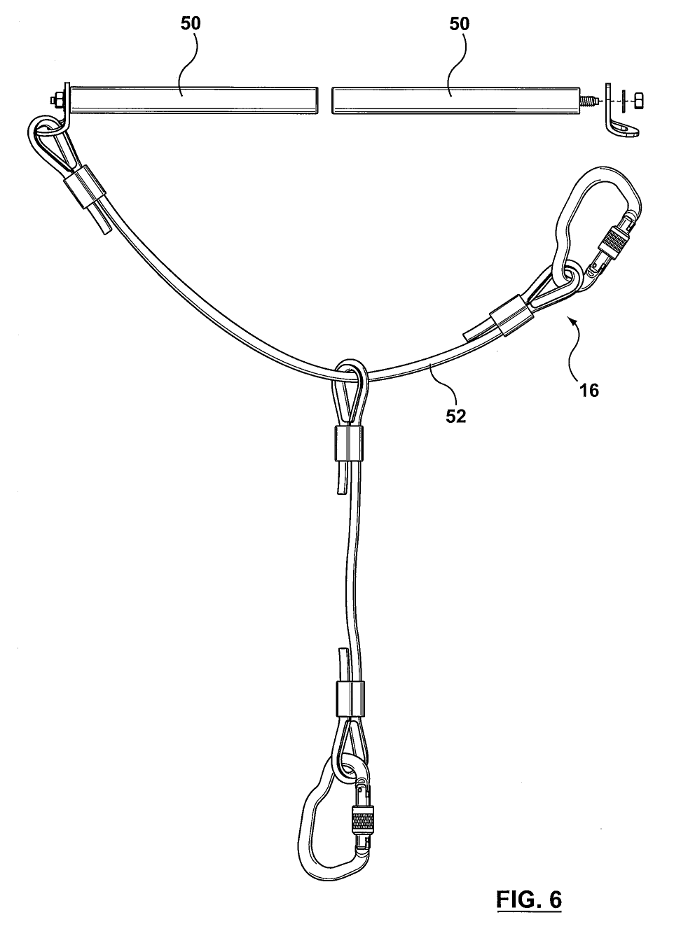

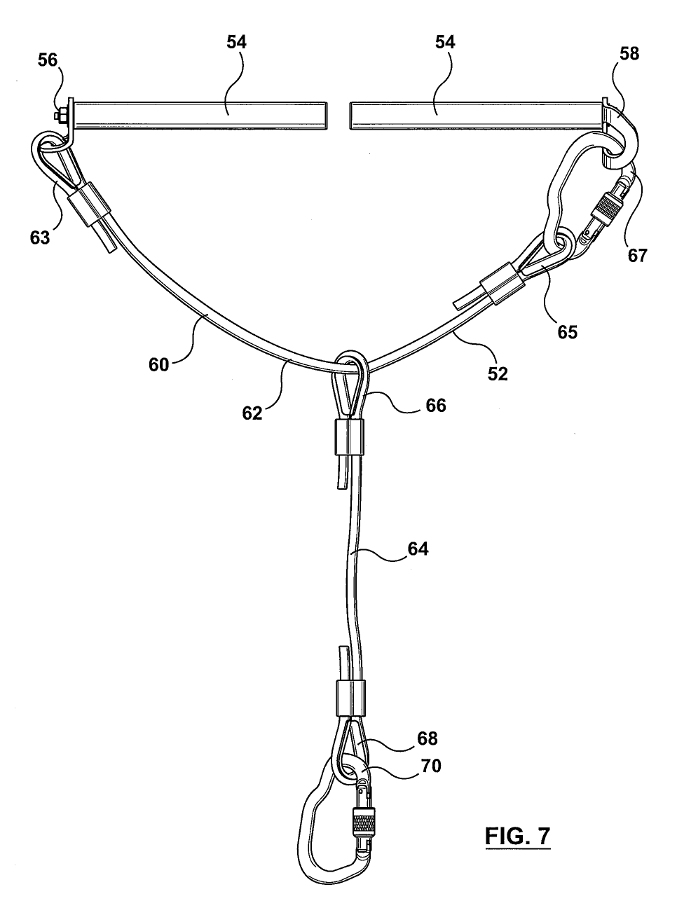

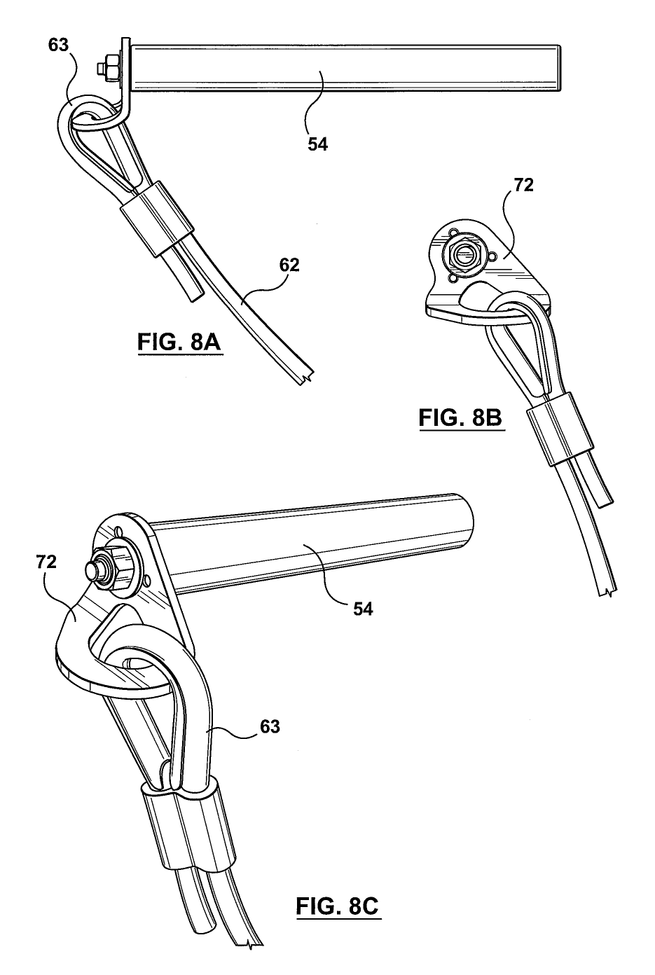

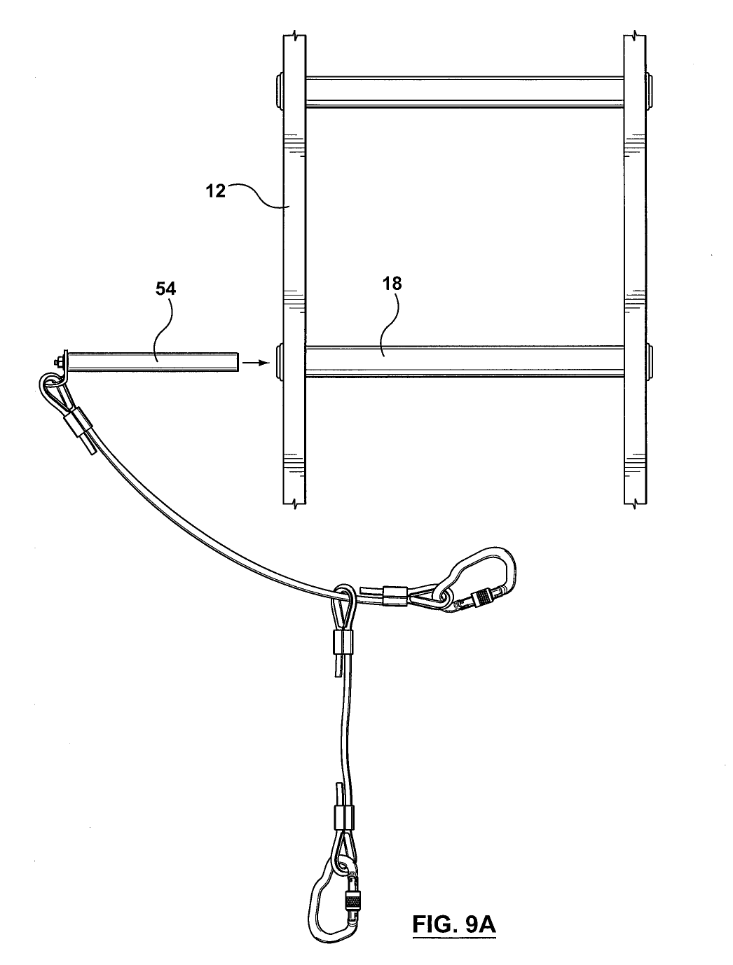

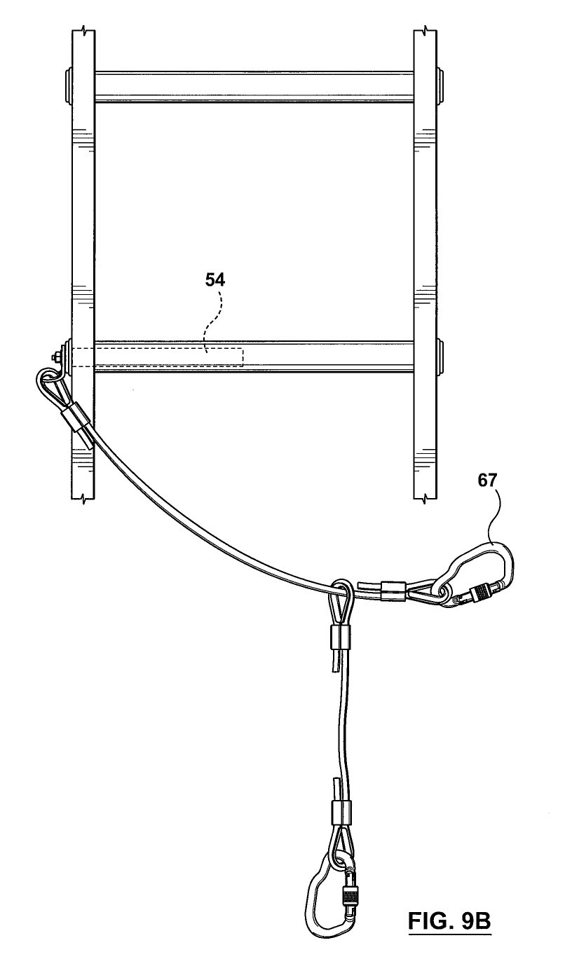

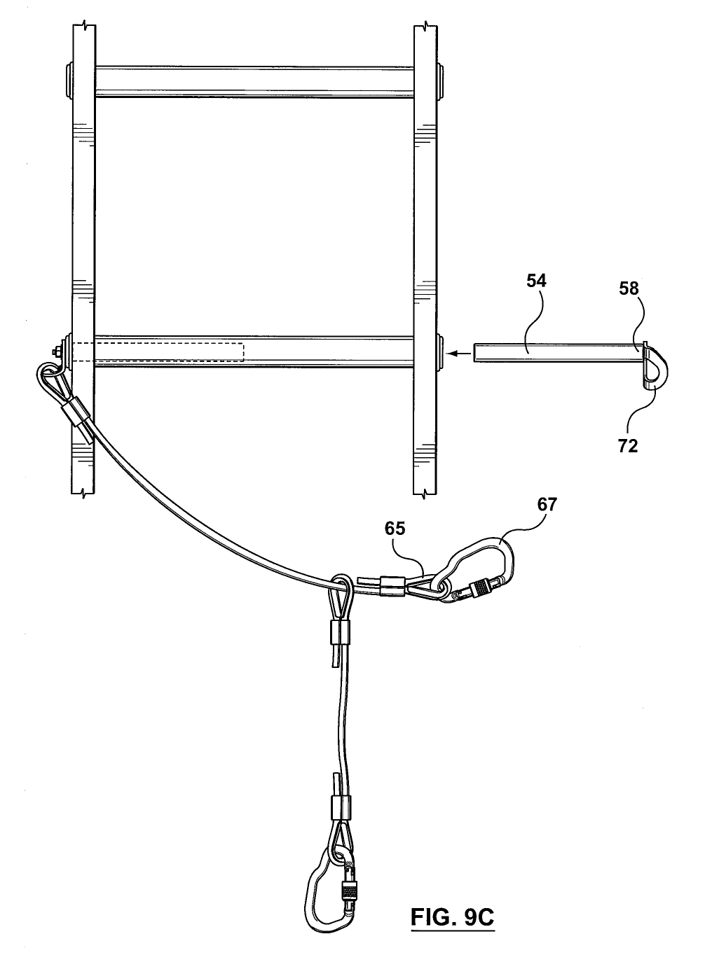

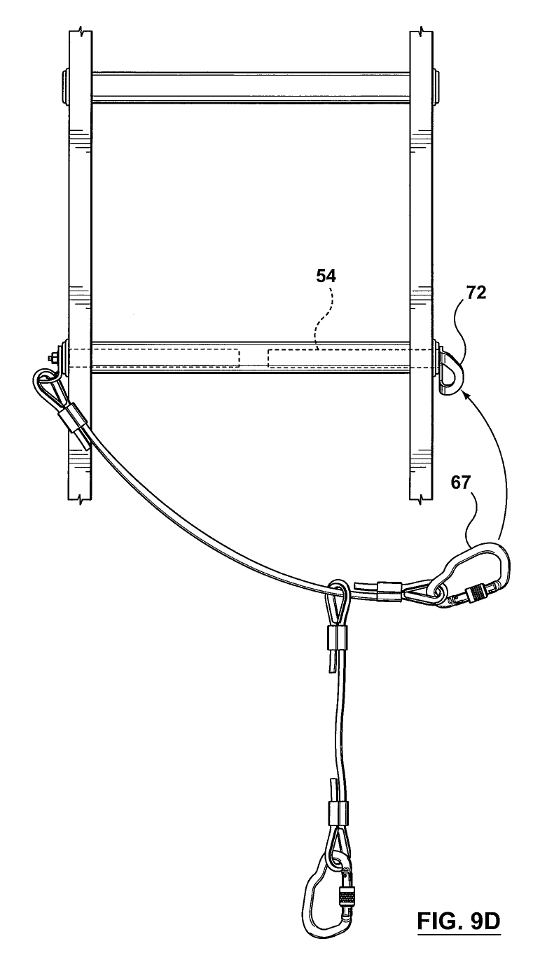

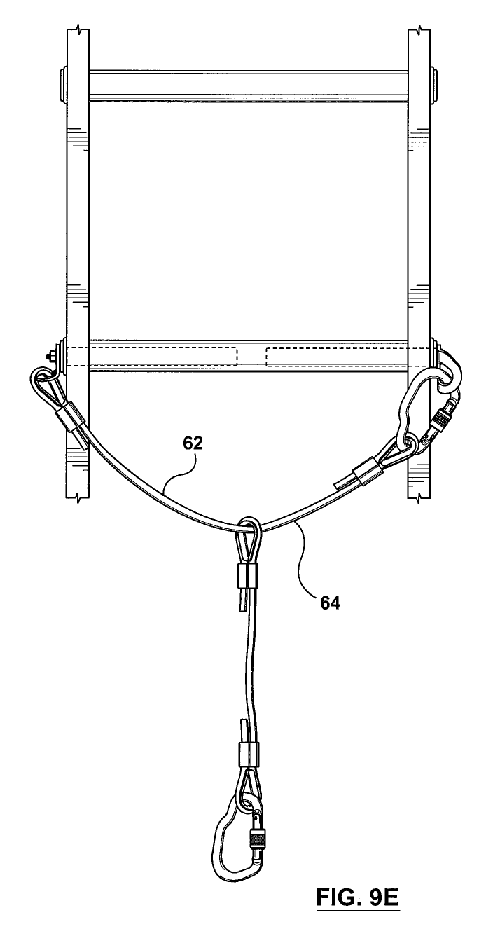

Referring to FIGS. 6 to 9 the anchoring means 16 may include at least one holding member 50 adapted to engage the ladder 12 and a detachable securing means 52 adapted to detachably engage both the holding member 50 and the person. The holding member 50 may be further defined as a hanger 54 having a first end 56 and a second end 58 that is sized to slide fit into the hollow rung 18 of the ladder 12. The securing means 52 may include a detachable flexible member 60 adapted to engage the hangers 54. The flexible member 60 may include a first portion 62 for engaging the first end 56 and the second end 58 of the hanger 54, and a second portion 64 that slidably engages the first portion 62. The first portion 62 may have a first end 63 and a second end 65, whereby the second end 65 may further include a first self-locking carabineer 67. The second portion 64 has a first end 66 for attachment to the first portion 62 and a second end 68 that is removably attachable to the person. The second end 68 may further include a second self-locking carabineer 70 for the quick attachment and removal of the anchoring system 16 to the person and specifically a safety harness worn by the person.

The first end 63 of the first portion 62 may be secured to the hanger 54 using a bolt and bracket system 72. The second end 65 of the first portion 62 may include the first self-locking carabineer 67 that can be removably attached to the bolt and bracket system 72 at the second end 58 of the hanger 54. Typically the anchoring system 16 includes two hangers 54 that slide into the hollow rungs 18 of the ladder 12. Once the first hanger 54 is positioned within the hollow rung 18 of the ladder 12, the second hanger 54 is slid into the same hollow rung 18 but from the other side of the ladder 12. Once positioned, the second end 65 of the first portion and the self-locking carabineer 67 may be removably attached to the bolt and bracket system 72 at the second end 58 of the hanger 54. The second portion 64 may then slidably move on the first portion 62. Typically the first and second portions 62 and 64 respectively are made from metal rope.

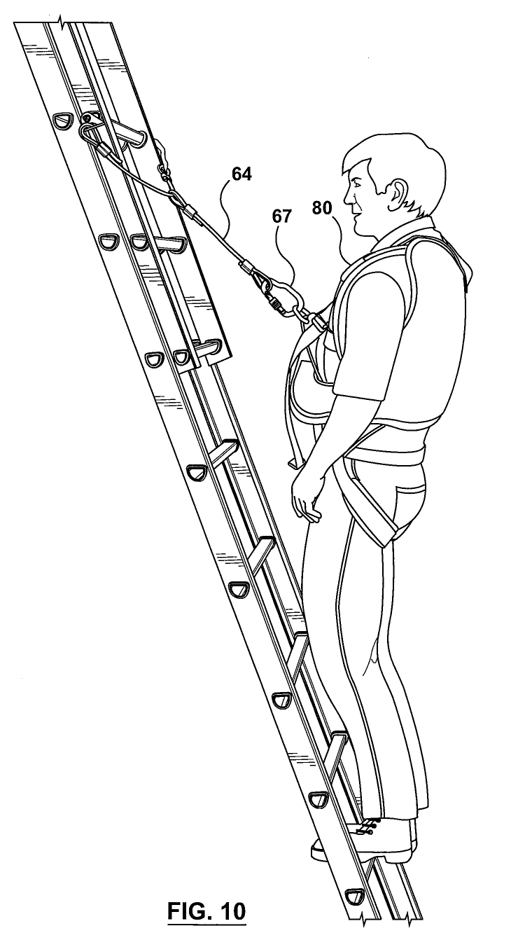

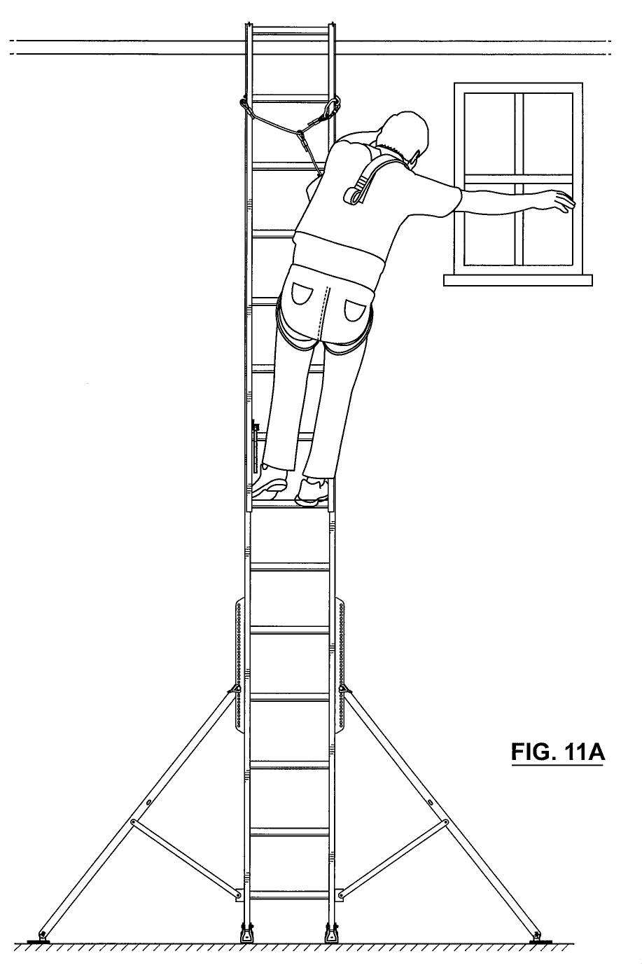

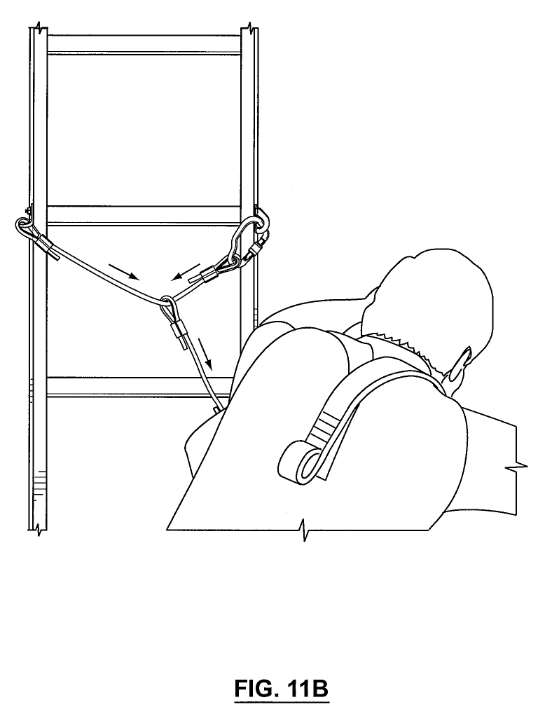

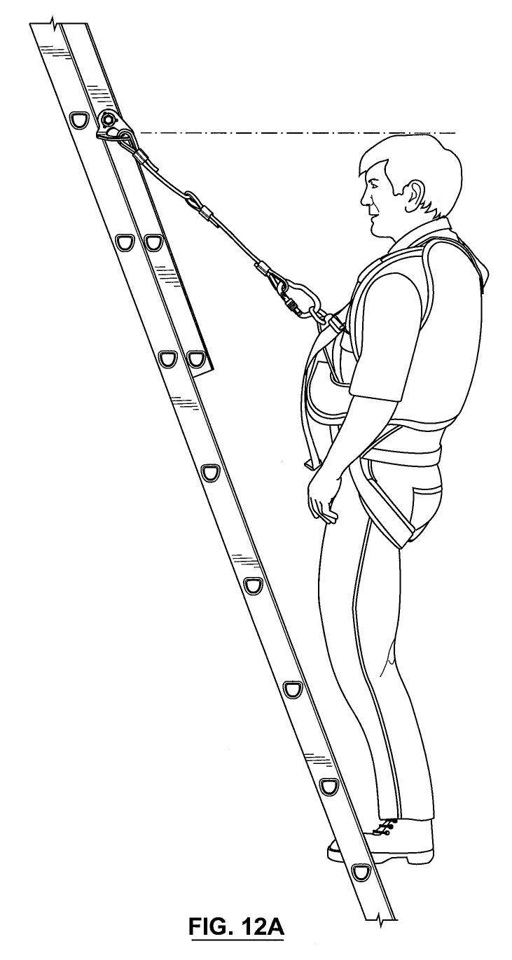

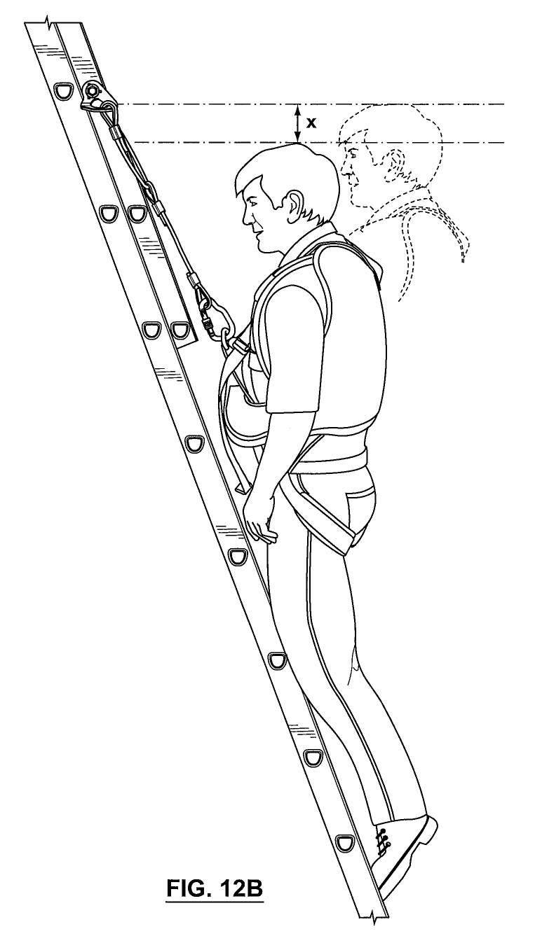

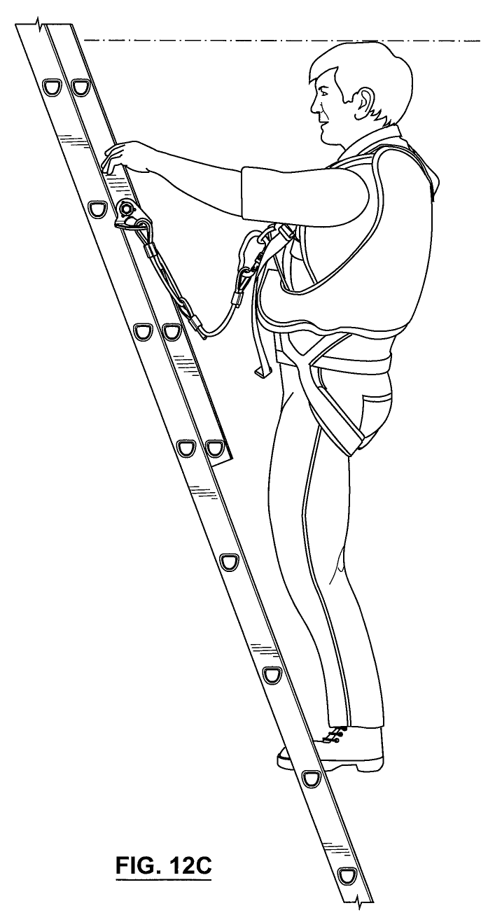

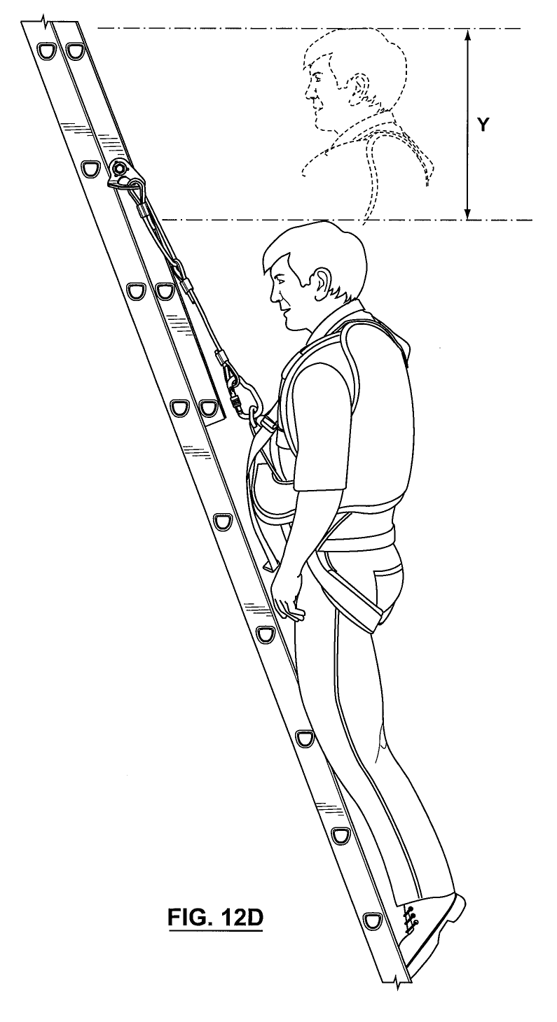

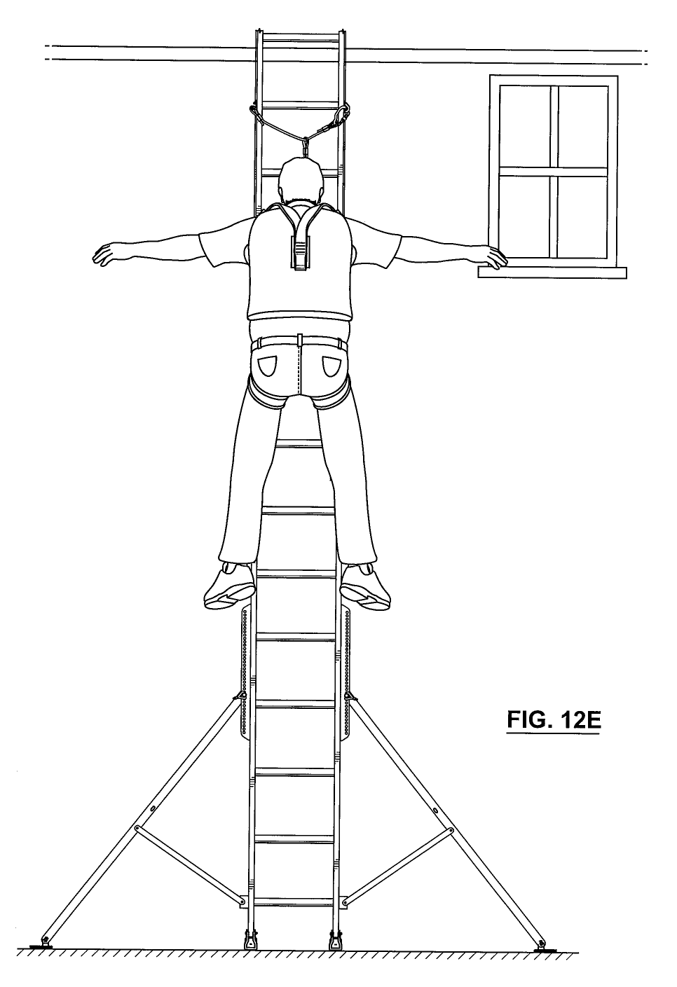

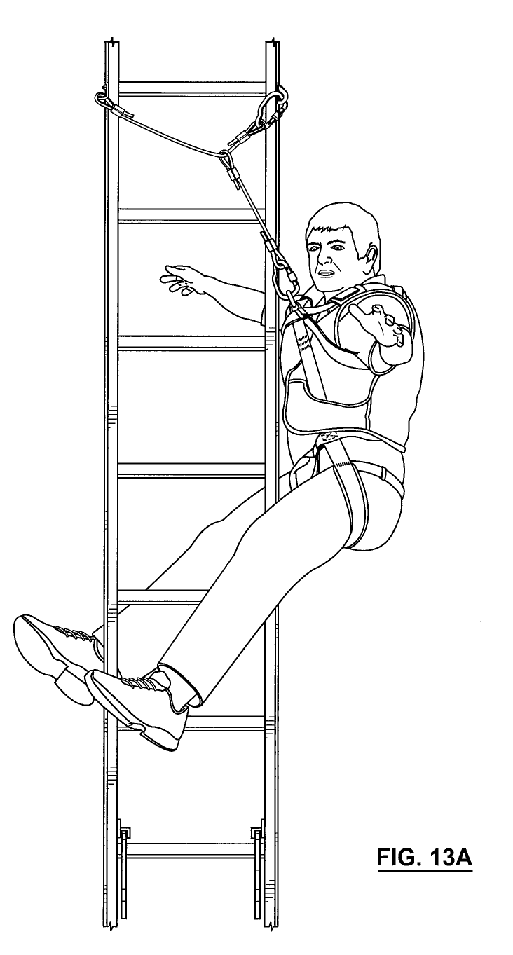

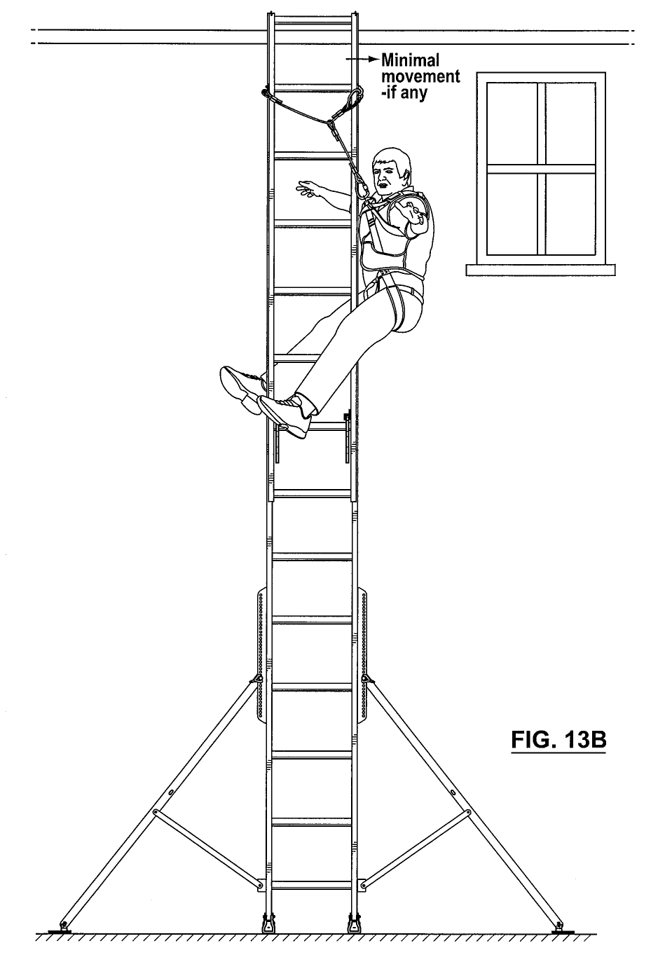

Referring to FIGS. 10 to 13, in operation the person is attached to the anchoring system 16 by the attachment of the second carabineer 67 to the safety harness 80. The length of the second portion 64 is only sufficient for the person to lean back from the ladder 12 without adding sufficient weight to tip the ladder 12 back away from the object that the ladder 12 is leaning against. Furthermore the extended length of the first and second portions, 62 and 64 respectively, combined only allows the person to fall a maximum of nine inches should the person fall off the ladder 12. Typical laws require that an anchoring system withstand thirteen hundred and fifty pounds. The current fall restrictive system 10 has been tested effective in excess of four thousand pounds. Furthermore the engaged fall restrictive system 10 allows for hands-free work by the person.

It will be appreciated by those skilled in the art that other variations of the preferred embodiment may also be practised without departing from the scope of the invention.

What is claimed is:

1. A fall restricting system for a person comprising:
(a) a ladder having hollow rungs;
(b) a stablizing system adapted to pivotally engage the ladder and ground; and
(c) an anchoring system adapted to engage the ladder and the person.

2. A fall restricting system for a person as claimed in claim 1 wherein the stabilizing system has at least one support arm for pivotally engaging the ladder and a least one stabilizing arm adapted to engage the ground and at least one adjusting means.

3. A fall restricting system for a person as claimed in claim 2 wherein support arm includes a first end and a second end and is removably mounted to the ladder via an attachment system at the first end.

4. A fall restricting system for a person as claimed in claim 3 wherein the attachment system further comprises a threaded support that is inserted into the hollow rung of the ladder.

5. A fall restricting system for a person as claimed in claim 4 wherein the threaded support further comprises a bracket to which the first end of the support arm and is secured to by a fastening means so that the support arm is allowed to pivot relative to the ladder.

6. A fall restricting system for a person as claimed in claim 5 wherein the second end of the support arm is secured to the stabilizing arm using a fastening means allowing the support arm to pivot relative the stabilizing arm.

7. A fall restricting system for a person as claimed in claim 6 wherein there are two support arms mounted to the ladder and to the stabilizing arm.

8. A fall restricting system for a person as claimed in claim 6 wherein the stabilizing arm further comprises a first end and a second end and the support arm engages the stabilizing arm at a mid-point between the first and second ends of the stabilizing arm.

9. A fall restricting system for a person as claimed in claim 8 wherein the first end of the stabilizing arm is adapted to pivotally engage the adjusting means using a lock and pin system.

10. A fall restricting system for a person as claimed in claim 9 wherein the second end of the stabilizing arm is adapted to engage a pivoting footing member.

11. A fall restricting system for a person as claimed in claim 10 wherein pivoting footing member can pivot up and down as well as from side to side by using an elongated slot in the pivoting footing member.

12. A fall restricting system for a person as claimed in claim 11 wherein the adjusting means further comprises a bracket to fit against the ladder and can be secured to the ladder through an attachment means.

13. A fall restricting system for a person as claimed in claim 12 wherein the bracket further comprises a series of apertures that are adapted to engage the first end of the stabilizing arm and the lock and pin system allowing the stabilizing arm to pivot relative the adjusting means.

14. A fall restricting system for a person as claimed in claim 1 wherein the anchoring means further comprises at least one holding member adapted to engage the ladder and a detachable securing means adapted to detachably engage both the holding member and the person.

15. A fall restricting system for a person as claimed in claim 14 wherein the holding member further includes a hanger having a first end and a second end that is sized to slide fit into the hollow rung of the ladder.

16. A fall restricting system for a person as claimed in claim 15 wherein the securing means includes a detachable flexible member adapted to engage the hangers.

17. A fall restricting system for a person as claimed in claim 16 wherein the flexible member comprises a first portion for engaging the first end and the second end of the hanger, and a second portion that slidably engages the first portion.

18. A fall restricting system for a person as claimed in claim 17 wherein the first portion has a first end and a second end, whereby the second end includes a first self-locking carabineer and the second portion has a first end for attachment to the first portion and a second end that includes a second self-locking carabineer for the quick attachment and removal of the anchoring system to the person.

19. A fall restricting system for a person as claimed in claim 18 wherein the first end of the first portion is secured to the hanger using a bolt and bracket system.

20. A fall restricting system for a person as claimed in claim 19 wherein the anchoring system comprises two hangers that slide into the hollow rungs of the ladder.
